(19) United States
(12) Patent Application Publication
(10) Pub. No.: US 2014/0245019 A1
(43) Pub. Date: Aug. 28, 2014

(54) APPARATUS FOR GENERATING PRIVACY-PROTECTING DOCUMENT AUTHENTICATION INFORMATION AND METHOD OF PERFORMING PRIVACY-PROTECTING DOCUMENT AUTHENTICATION USING THE SAME

(71) Applicant: Electronics and Telecommunications Research Institute, Daejeon (KR)

(72) Inventors: Jung-Yeon HWANG, Daejeon (KR); Ku-Young CHANG, Daejeon (KR); Nam-Su JHO, Daejeon (KR); Taek-Young YOUN, Seongnam-si (KR); Hyun-Sook CHO, Daejeon (KR)

(73) Assignee: Electronics and Telecommunications Research Institute, Daejeon (KR)

(21) Appl. No.: 14/142,165

(22) Filed: Dec. 27, 2013

(30) Foreign Application Priority Data
Feb. 27, 2013 (KR) 10-2013-0021262

(51) Int. Cl. G06F 21/64

(52) U.S. Cl. CPC G06F 21/64
USPC 713/176

(57) ABSTRACT

Disclosed herein are an apparatus for generating the privacy-protecting document authentication information and a method of performing privacy-protecting document authentication. The apparatus for generating the privacy-protecting document authentication information includes an electronic signature information generation unit, a multi-dimensional code generation unit, and a multi-dimensional code output unit. The electronic signature information generation unit generates electronic signature information for the content of an input document. The multi-dimensional code generation unit generates a multi-dimensional code corresponding to the generated electronic signature information. The multi-dimensional code output unit outputs the generated multi-dimensional code onto the document.

### CROSS-REFERENCE TO RELATED APPLICATION

This application claims the benefit of Korean Patent Application No. 10-2013-0021262, filed on Feb. 27, 2013, which is hereby incorporated by reference in its entirety into this application.

### BACKGROUND OF THE INVENTION

1. Technical Field

The present invention relates generally to an apparatus for generating privacy-protecting document authentication information and a method of performing privacy-protecting document authentication using the same and, more particularly, to an apparatus for generating privacy-protecting document authentication information and a method of performing privacy-protecting document authentication using the same, which, using privacy-protecting electronic signatures, can authenticate a document and can verify that a plurality of documents is associated with each other for a specific purpose.

2. Description of the Related Art

Conventionally, the authentication of documents, such as contracts, commercial transaction documents, and official documents, has been generally provided via legal or registered seals, thumbprints, or handwritten signatures. After it has been determined that a document is not forged, a specific purpose, such as the tallying of the document, the authentication of the origin of the document or non-repudiation, can be achieved through such authentication.

To realize the purpose and function of a conventional legal or registered seal in a digital environment, a method of authenticating a user or a digital message via an electronic signature based on a public or private certificate is widely used to provide authentication, integrity, non-repudiation, and/or the like in the field of Internet banking.

A conventional public key infrastructure (PKI) authentication technique that is currently widely used has disadvantages in terms of the protection of privacy. When authentication is provided using a PKI-based electronic signature, information about the real name of a signer may be exposed to the outside. Furthermore, it has other disadvantages, such as the exposure of private information combined with an authentication service, the excessive collection of the personal information of a service provider, and the divulgence of information attributable to careless management, and the wide tracking of human activities.

Recently, various electronic signature techniques for protecting the privacy of users have been actively researched and proposed. A group signature that was first proposed by Chaum and Heyst in 1991 has been greatly developed as a typical signature technique for providing anonymous authentication. Many specific techniques as well as various security requirements and formal models have been proposed. Furthermore, recently, a group signature technique that provides controllable connectivity capable of effectively controlling anonymity and connectivity (see Korean Patent Application Publication No. 10-2012-0071015 entitled “Short Group Signature Apparatus and Schemes with Controllable Linkability”) is being actively researched. The group signature technique for providing controllable connectivity disclosed in Korean Patent Application Publication No. 10-2012-0071015 extends conventional group signature techniques for simply addressing anonymity in a dichotomous structure in which the identity information or identification (ID) of a signer is concealed and restored, and additionally includes “controllable connectivity” in which when a particular linking key is given, it can be determined that signature values are linked to one another (that is, signature values were generated by the same signer or the same key). Therefore, it can be controlled according to policies that require anonymity at various levels.

Usually, the application of the protection of privacy is of primary concern in an online environment. The reason for this is that many fields of application in an online environment have been developed and proposed based on various electronic signature techniques for protecting privacy.

A case where a document is authenticated by checking an identity card and appending a conventional legal or registered seal to a document has disadvantages in terms of the protection of privacy, like the conventional PM authentication technique. Recently, an application that prints a conventional PKI electronic signature on a document and then uses the function of the PM electronic signature also has disadvantages in terms of the protection of privacy.

The authentication of documents is being widely used in real life. The authentication of documents is mostly processed based on real name authentication regardless of a case where the protection of privacy is highly required. In an application environment in which document authentication information is added to a document without requiring a person to verify a document in his or her person, another authentication method for protecting privacy is required. Signature or authentication for protecting privacy may be used in a case where a legal agent representative of a company is designated.

Using the above-described features, privacy-protecting document authentication can be safely used in various fields of application including the field of online and offline convergence. For example, if only connectivity information is extracted using privacy-protecting document authentication, the exposure of identity information is minimized, and the correlation between documents is easily identified, thereby conveniently processing the documents. Therefore, if privacy-protecting digital signature can be used as a method of authenticating documents, like PKI electronic signature based on real name authentication, it can be expected that a wide field of application will be created.

Meanwhile, multi-dimensional code is attracting attention as a medium that will play an important role in linking online and offline environments with each other in terms of the use of information. Multi-dimensional code is a medium that conveniently transfers information using widely popularized smart devices, and is expected to be utilized in a practical form. Multi-dimensional code enables numbers, letters, special signs, and the like to be coded using combinations of black-and-white bar widths, matrices, shapes, patterns, colors, and the like so that the numbers, the letters, the special signs, and the like can be easily read optically. Multi-dimensional code can integrate data at high density, and thus is applied and utilized in various identity cards, the medical field, marketing, air carriers, and manufacturing and administration fields as well as for the improvement of circulation and distribution.

About 600 types of multi-dimensional or two-dimensional code are known all over the world, and quick response (QR) code (Denso Wave) in Japan, portable document format (PDF) 417 (Symbol Technologies), Data Matrix (International Data Matrix), and MaxiCode (UPS) in US, and the standard codes of various countries in Europe are being used. Furthermore, multi-dimensional color codes, such as a high-capacity color barcode known as a smart tag after being developed in early 2009 by Microsoft Corporation and a color code by Colorzip Korea Co., Ltd. in Korea, are being developed.

As a conventional art regarding the present invention, Korean Patent Application Publication No. 10-2012-0049678 discloses technology entitled “Two-dimensional Code Stamp and Method of Providing Information Using the Same.” The technology disclosed in Korean Patent Application Publication No. 10-2012-0049678 is configured to provide a two-dimensional code stamp that facilitates the distribution of a two-dimensional code, that enables the rapid distribution of the two-dimensional code, and that supports easy identification.

For this purpose, the two-dimensional code stamp disclosed in Korean Patent Application Publication No. 10-2012-0049678 includes a carving member configured to have a two-dimensional code carved on one side thereof, and a radio frequency (RF) tag configured to store identification information that is used to identify a two-dimensional code carved in each of a plurality of two-dimensional code stamps. The two-dimensional code stamp may be provided in the form of an eternity stamp. According to the technology disclosed in Korean Patent Application Publication No. 10-2012-0049678, a desired two-dimensional code stamp can be identified from among a number of two-dimensional code stamps using RF tags, and a two-dimensional code can be rapidly and easily distributed by stamping the two-dimensional code stamp.

Korean Patent Application Publication No. 10-2012-0049678 presents merely the method of identifying a desired two-dimensional code stamp from among a number of two-dimensional code stamps using RF tags and rapidly stamping the desired two-dimensional code stamp, and fails to present a method of authenticating a document using an electronic signature protecting privacy. Furthermore, Korean Patent Application Publication No. 10-2012-0049678 also fails to present a method of checking the connectivity between documents and facilitating the processing of documents by utilizing connectivity information, that is, a privacy attribute.

Furthermore, as another conventional art regarding the present invention, Korean Patent No. 10-0729600 discloses technology entitled “Method for Issuing Online Certificate Over Internet.” The technology disclosed in Korean Patent No. 10-0729600 is configured such that a certificate issuance agency receives a certificate from a certificate generation system and transfers the certificate to a person who requested the certificate.

For this purpose, the method disclosed in Korean Patent No. 10-0729600 includes a first step at which a certificate issuance agency system downloads and installs a certificate viewer program and a barcode generation program for generating a two-dimensional barcode included in a certificate to and in a certificate request system in order to prevent the forgery of the certificate when the certificate request system is connected to the certificate issuance agency system; a second step at which the certificate issuance agency system transfers a certificate issuance request message to a certificate generation system when the certificate issuance request message is input via the certificate request system; a third step at which the certificate generation system generates the certificate in a Windows metafile or appends an electronic signature to the generated certificate, and transfers the certificate to the certificate issuance agency system, in response to the certificate issuance request message; a fourth step at which the certificate issuance agency system assigns a unique document identification number to the certificate transferred at the third step, appends an electronic signature to the certificate and then compresses the certificate, or assigns a unique document identification number to the transferred certificate to which an electronic signature has been appended and then compresses the certificate; a fifth step at which the certificate issuance agency system issues the document identification number, the compressed certificate, and the Windows metafile certificate to the certificate request system; a sixth step at which the certificate request system displays the Windows metafile certificate on a screen by executing the certificate viewer program and generates the two-dimensional barcode by inputting the document identification number and the compressed certificate to the barcode generation program; and a seventh step at which the certificate request system generates a printing certificate including the Windows metafile certificate and the two-dimensional barcode.

Since Korean Patent No. 10-0729600 is configured merely to issue certificates based on electronic signatures based on real name authentication (for example, based on the PKI) and barcodes over the Internet, it is weak in terms of the protection of user privacy, and fails to present a method of authenticating documents using privacy-protecting electronic signatures.

### SUMMARY OF THE INVENTION

Accordingly, the present invention has been proposed to solve the above conventional problems, and the present invention is intended to provide an apparatus for generating privacy-protecting document authentication information using various privacy-protecting electronic signatures and multi-dimensional codes, and a method of performing privacy-protecting document authentication using the same.

In accordance with an aspect of the present invention, there is provided an apparatus for generating privacy-protecting document authentication information, including an electronic signature information generation unit configured to generate electronic signature information for the content of an input document; a multi-dimensional code generation unit configured to generate a multi-dimensional code corresponding to the generated electronic signature information; and a multi-dimensional code output unit configured to output the generated multi-dimensional code onto the document.

The content of the document may include one or more of text information, a photograph, a picture, biometric information, audio information, financial information, and a moving picture.

The electronic signature information generation unit may additionally receive one or more of user-private information, a watermark, a signature, and ciphertext, and may include the additionally received information in the electronic signature information.

The multi-dimensional code output unit may receive the multi-dimensional code from the multi-dimensional code generation unit via a recognizing device.

The multi-dimensional code output unit may receive the multi-dimensional code from the multi-dimensional code generation unit using a wired cable or wireless data transfer method.

The multi-dimensional code output unit may output the multi-dimensional code onto the document as a plurality of multi-dimensional codes so that the plurality of multi-dimensional codes is spaced apart from each other.

The apparatus may further include a storage unit configured to store the generated multi-dimensional code.

In accordance with another aspect of the present invention, there is provided a method of performing privacy-protecting document authentication, including scanning, by a scanning unit, a multi-dimensional code on a document on which the multi-dimensional code including electronic signature information is indicated; decoding, by a decoding unit, the scanned multi-dimensional code; extracting, by an electronic signature information extraction unit, the electronic signature information from results of the decoding; and verifying, by a verification unit, the extracted electronic signature information.

The electronic signature information may additionally include one or more of user-private information, a watermark, a signature, and ciphertext; and the decoding may decode the additionally included information together with the multi-dimensional code.

The extracting may extract the additionally included information together with the electronic signature information.

The verifying may verify the additionally included information together with the electronic signature information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a system to which the present invention is applied;

FIG. 2 is a diagram illustrating the internal configuration of the first user device illustrated in FIG. 1;

FIG. 3 is a diagram illustrating the internal configuration of the second user device illustrated in FIG. 1;

FIG. 4 is a flowchart illustrating a process of generating privacy-protecting document authentication information and a process of performing privacy-protecting document authentication according to an embodiment of the present invention; and

FIG. 5 is a diagram that is used to describe the flowchart of FIG. 4.

### DESCRIPTION OF THE PREFERRED EMBODIMENTS

The present invention is directed to an apparatus and a method in which a user generates (converts) privacy-protecting electronic signature (or authentication) information as (into) a multi-dimensional code for the content of a specific document and then outputs it onto the document via a specific output device and a verifier scans the multi-dimensional code indicated on the document and then verifies the signature (or authentication) information associated with the content of the document, thereby authenticating the document or verifying a privacy attribute, such as the connectivity between documents.

An apparatus for generating privacy-protecting document authentication information and a method of performing privacy-protecting document authentication using the same according to the present invention will be described with reference to the accompanying drawings. Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the examples at the time at which the present application is filed.

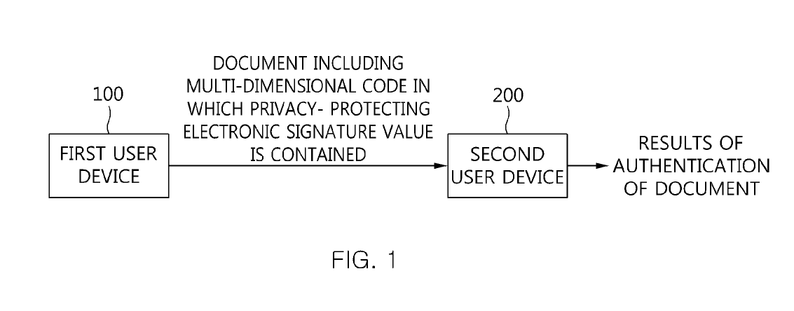

FIG. 1 is a diagram illustrating the configuration of a system to which the present invention is applied. This drawing illustrates a basic configuration of the system that represents a privacy-protecting electronic signature for the related content of a document using a multi-dimensional code, and outputs the multi-dimensional code onto the document, thereby performing recognition and authenticating the document.

The system of FIG. 1 includes a first user device 100 and a second user device 200.

The first user device 100 generates a privacy-protecting electronic signature that provides a specific security function, such as authentication, for the content of a given document. The first user device 100 generates a multi-dimensional code corresponding to the generated privacy-protecting electronic signature. The first user device 100 outputs the generated multi-dimensional code onto the document. If necessary, the first user device 100 may be divided into a user device 1 configured to generate a multi-dimensional code corresponding to a privacy-protecting electronic signature and a user device 2 configured to output the generated multi-dimensional code onto a document.

The second user device 200 receives the document output from the first user device 100, and then scans the multi-dimensional code output (indicated) onto the document. The second user device 200 extracts document-related signature information from the scanned multi-dimensional code, and checks the document for authentication, tallies and security properties.

The first user device 100 and the second user device 200 may be viewed as being based on the concept of an algorithm that outputs a particular value for a given input value. The configuration of the system to which the present invention is applied is not limited only to the configuration illustrated in FIG. 1, and the configuration may be divided into sub-configurations or combined with another configuration depending on design. If necessary, a new configuration may be defined.

Meanwhile, when the maintenance of confidentiality is essential, communication data between the first user device 100 and the second user device 200 is encrypted and sent using a predetermined method.

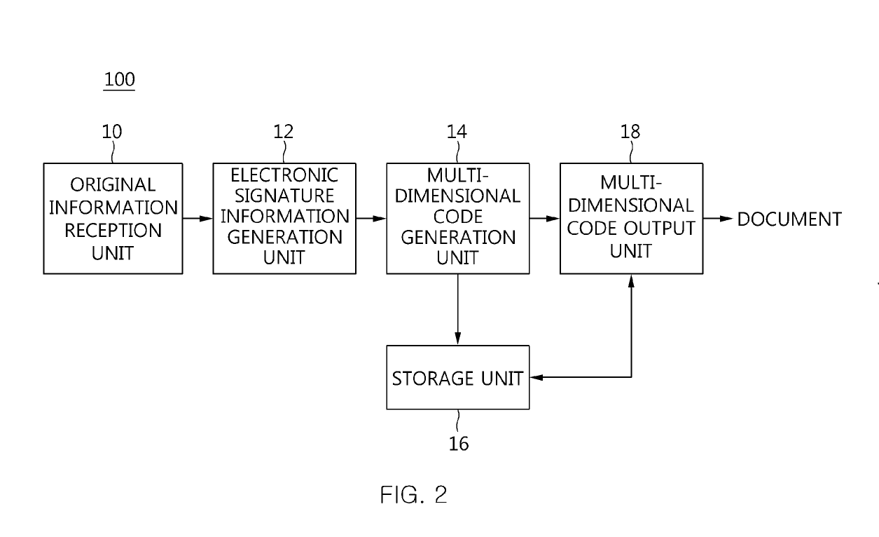

FIG. 2 is a diagram illustrating the internal configuration of the first user device 100 illustrated in FIG. 1. The first user device 100 may be viewed as an apparatus for generating privacy-protecting document authentication information according to an embodiment of the present invention.

The first user device 100 includes an original information reception unit 10, an electronic signature information generation unit 12, a multi-dimensional code generation unit 14, a storage unit 16, and a multi-dimensional code output unit 18.

The original information reception unit 10 receives the content of a first document to be signed. In this case, the first document content becomes original information, and the original information may range from simple text information to a large amount of very complicated information, such as a photograph, a picture, biometric information, audio information, high capacity text, financial information, a moving picture, or the like.

The electronic signature information generation unit 12 generates privacy-protecting electronic signature information that provides a specific security function, such as authentication, for the content of a document that is received by the original information reception unit 10. It will be apparent that upon transferring the generated privacy-protecting electronic signature information to the multi-dimensional code generation unit 14, the electronic signature information generation unit 12 may insert and combine intended information into and with the privacy-protecting electronic signature information, and thus various security and authentication functions can be provided when the multi-dimensional code is indicated. In this case, the intended information includes one or more of user-private information, a watermark, a signature, ciphertext or the like, and may include various types of information, techniques and the like that can improve security and authentication effects. That is, the electronic signature information generation unit 12 may further receive one or more of user-private information, a watermark, a signature or ciphertext and include them in the privacy-protecting electronic signature information.

The multi-dimensional code generation unit 14 generates a pattern image, such as a multi-dimensional code, that corresponds to the privacy-protecting electronic signature information that is generated by the electronic signature information generation unit 12. That is, the multi-dimensional code generation unit 14 converts privacy-protecting electronic signature information into a corresponding multi-dimensional code using a predetermined method. For example, a method may be used in which the multi-dimensional code generation unit 14 stores pattern images that match privacy-protecting electronic signature information in advance, and extracts a matching pattern image from among the previously stored pattern images when privacy-protecting electronic signature information is generated. Alternatively, privacy-protecting electronic signature information may be converted into a corresponding multi-dimensional code using a separate program that converts privacy-protecting electronic signature information into a pattern image.

The storage unit 16 stores the multi-dimensional code and the related information that are generated by the multi-dimensional code generation unit 14. In this case, the related information may include the privacy-protecting electronic signature information, and one or more of user-private information, a watermark, a signature and ciphertext that are additionally input.

The multi-dimensional code output unit 18 outputs the multi-dimensional code generated by the multi-dimensional code generation unit 14 onto a document.

The first user device 100 that is configured as described above may use various privacy-protecting electronic signature techniques in order to achieve various security purposes. For example, an anonymity-controlled signature and a full anonymity-based ring signature, such as a group signature, a direct anonymous attestation (DAA) signature for providing only connectivity control, or a privacy-protecting electronic signature for providing anonymity and connectivity control may be used. In some cases, various electronic signature techniques, such as a proxy signature technique that can delegate authority to sign, may be combined with each other. Furthermore, a symmetric key-based authentication technique, such as one-time password (OTP)-based authentication, may be used instead of an electronic signature technique. The electronic signature information generation unit 12 of the first user device 100 generates the privacy-protecting electronic signature information using any one of the various privacy-protecting electronic signature techniques that are described in the above example.

Meanwhile, methods using which the multi-dimensional code generation unit 14 transfers the multi-dimensional code to the multi-dimensional code output unit 18 may be various. For example, when the multi-dimensional code generation unit 14 indicates the multi-dimensional code, the multi-dimensional code output unit 18 may receive the indicated multi-dimensional code by scanning the indicated multi-dimensional code using a recognition device, such as a camera. For another example, the multi-dimensional code that is generated by the multi-dimensional code generation unit 14 may be transferred to the multi-dimensional code output unit 18 using a wired cable method or a wireless data transfer method.

If necessary, the multi-dimensional code generation unit 14 may be included in the multi-dimensional code output unit 18, and the multi-dimensional code output unit 18 may generate and output a multi-dimensional code that carries privacy-protecting electronic signature information.

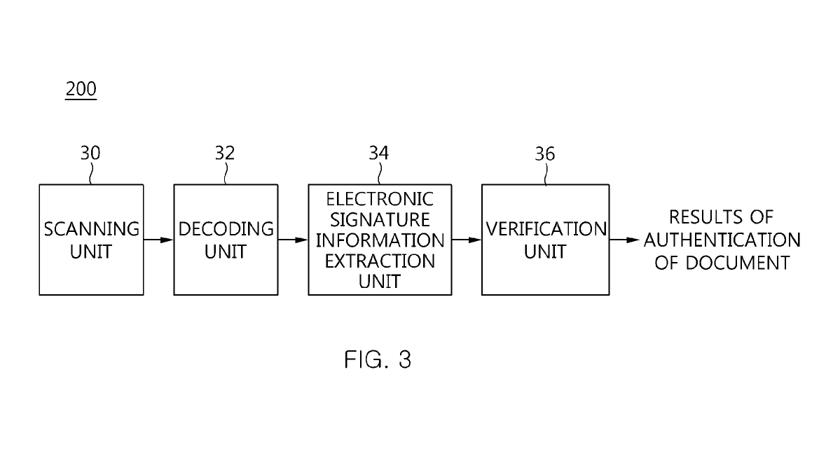

FIG. 3 is a diagram illustrating the internal configuration of the second user device 200 illustrated in FIG. 1. The second user device 200 may be viewed as an apparatus for performing privacy-protecting document authentication according to an embodiment of the present invention.

The second user device 200 includes a scanning unit 30, a decoding unit 32, an electronic signature information extraction unit 34, and a verification unit 36.

The scanning unit 30 receives a document from the first user device 100, and scans a multi-dimensional code that is indicated on the document. In this case, the scanning unit 30 may scan the multi-dimensional code using a recognition device, such as a camera.

The decoding unit 32 decodes the multi-dimensional code that is scanned by the scanning unit 30.

The electronic signature information extraction unit 34 extracts privacy-protecting electronic signature information from the results of the decoding that are obtained by the decoding unit 32.

The verification unit 36 verifies the privacy-protecting electronic signature information extracted by the electronic signature information extraction unit 34. Through this verification, the content of the document may be authenticated, several documents are authenticated as being associated with each other for a specific purpose, and various security properties, such as integrity and non-repudiation, may be verified.

When one or more of user-private information, a watermark, a signature and ciphertext have been additionally included in the privacy-protecting electronic signature information, the decoding unit 32 may decode the additionally included information together with the multi-dimensional code. Furthermore, the electronic signature information extraction unit 34 may extract the additionally included information together with the privacy-protecting electronic signature information. Moreover, the verification unit 36 may verify the additionally included information together with the privacy-protecting electronic signature information.

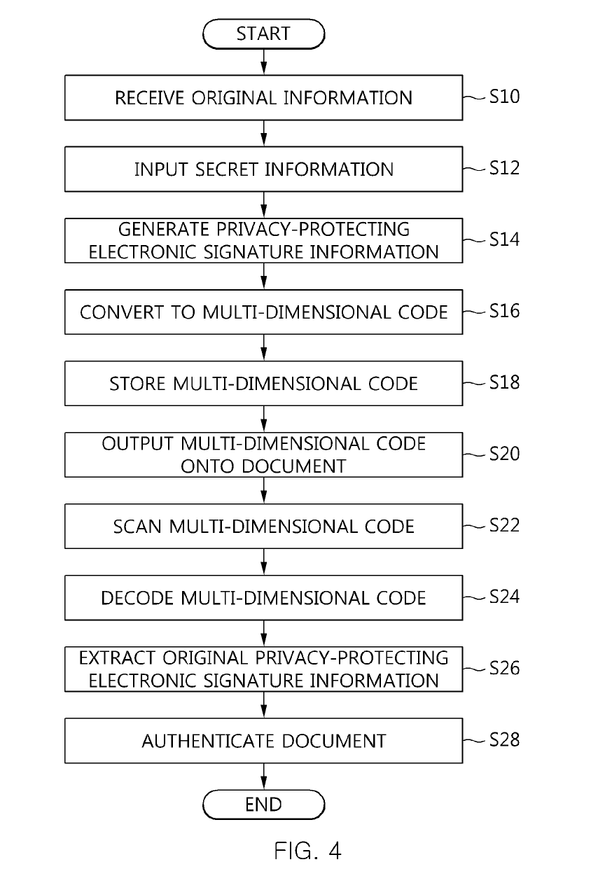

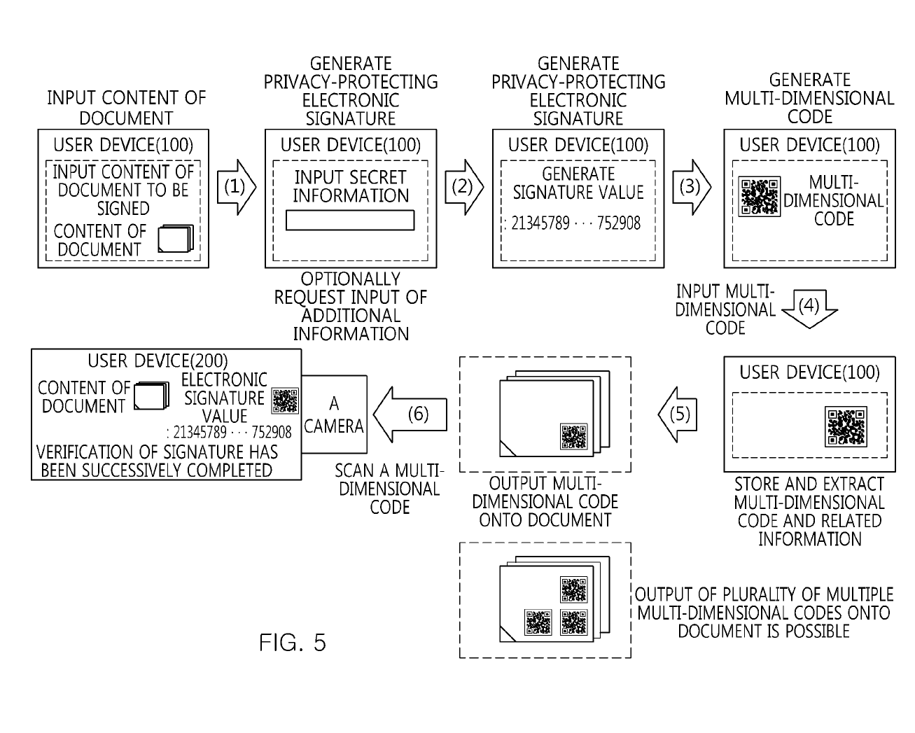

FIG. 4 is a flowchart illustrating a process of generating privacy-protecting document authentication information and a process of performing privacy-protecting document authentication according to an embodiment of the present invention, and FIG. 5 is a diagram that is used to describe the flowchart of FIG. 4.

First, the process of performing privacy-protecting document authentication that is performed by the first user device 100 will be described. The original information reception unit 10 receives the content of a first document (original information) at step S10. That is, the original information reception unit 10 receives the content of a document to be signed.

Thereafter, the electronic signature information generation unit 12 requests the input of additional information to be included in the generation of electronic signature information and receives additional information when the additional information, such as user-private information, a watermark, a signature or ciphertext, is input by a user in response to the request at step S12.

If additional information, such as user-private information, a watermark, a signature or ciphertext, is input upon generating the privacy-protecting electronic signature information for the received content of the first document, the electronic signature information generation unit 12 may include the additional information in the privacy-protecting electronic signature information at step S14. If the additional information is not input, the electronic signature information generation unit 12 generates the privacy-protecting electronic signature information only for the received original information.

Once the privacy-protecting electronic signature information has been generated by the electronic signature information generation unit 12, the multi-dimensional code generation unit 14 generates a pattern image, such as a multi-dimensional code, that corresponds to the privacy-protecting electronic signature information at step S16. The generated multi-dimensional code is stored in the storage unit 16 at step S18.

Meanwhile, the generated multi-dimensional code is sent to the multi-dimensional code output unit 18, and the multi-dimensional code output unit 18 outputs the received multi-dimensional code (including the privacy-protecting electronic signature information (for example, “21345789 . . . 752908”)) onto the document at step S20. A method of outputting the multi-dimensional code onto the document may be various. For example, the multi-dimensional code may be output onto the document in a manner similar to a manner in which a general printer performs output. In some cases, the document may be input to an output device together. A new output configuration that may print only the multi-dimensional code on the document may be used based on the principle of a dot printer. Alternatively, the multi-dimensional code may be printed on the document using a method similar to the principle of copying or photo printing. If necessary, the multi-dimensional code to be output onto the document may be output as a plurality of multi-dimensional codes using a predetermined method. That is, the multi-dimensional code output unit 18 may output the multi-dimensional code onto the document as a plurality of multi-dimensional codes so that the plurality of multi-dimensional codes is spaced apart from each other.

Through the above-described steps S10 to S20, the generation of the privacy-protecting document authentication information according to this embodiment of the present invention may be performed.

Next, the process of performing privacy-protecting document authentication that is performed by the second user device 200 will be described. As the multi-dimensional code is output (indicated) onto the document and then provided, the scanning unit 30 of the second user device 200 scans the multi-dimensional code of the document using a recognition device, such as a camera. The scanned multi-dimensional code is transferred to the decoding unit 32.

The decoding unit 32 decodes the scanned multi-dimensional code and transfers the results of the decoding to the electronic signature information extraction unit 34 at step S24. If additional information, such as user-private information, a watermark, a signature or ciphertext, was included when the electronic signature information was generated by the first user device 100, the decoding unit 32 also decodes the additional information.

The electronic signature information extraction unit 34 extracts the privacy-protecting electronic signature information from the results of the decoding obtained by the decoding unit 32 at step S26. If the user-private information, the watermark, the signature, the ciphertext, or the like additionally included in the electronic signature information was decoded together by the decoding unit 32, the electronic signature information extraction unit 34 also extracts the additionally included information.

The verification unit 36 verifies the extracted privacy-protecting electronic signature information. In this case, the user-private information, the watermark, the signature, the ciphertext, or the like may be additionally included in the extracted privacy-protecting electronic signature information. The verification unit 36 verifies the validity of the extracted privacy-protecting electronic signature. Furthermore, if necessary, the verification unit 36 may also verify the connectivity between electronic signatures by calculating connection information associated with the electronic signatures. Through this verification, the content of the document may be authenticated, several documents may be authenticated as being associated with each other for a specific purpose, and various security properties, such as integrity and non-repudiation, may be verified at step S28. In this case, the verification unit 36 may output the results of the verification.

Through the above-described steps S22-S28, the privacy-protecting document authentication according to this embodiment of the present invention may be performed.

According to the present invention configured as described above, a privacy-protecting electronic signature value that is generated on a personalized smart device is output onto a physical document in the form of a multi-dimensional code, thereby enabling the document to be authenticated.

Therefore, the present invention can not only replace the function of a physical signature or a legal seal that has been conventionally used but can also provide privacy-protecting document authentication using a multi-dimensional code effectively, and thus it is expected that the present invention will have a great ripple influence on the document authentication market.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for generating privacy-protecting document authentication information, comprising:
an electronic signature information generation unit configured to generate electronic signature information for content of an input document;
a multi-dimensional code generation unit configured to generate a multi-dimensional code corresponding to the generated electronic signature information; and
a multi-dimensional code output unit configured to output the generated multi-dimensional code onto the document.

2. The apparatus of claim 1, wherein the content of the document comprises one or more of text information, a photograph, a picture, biometric information, audio information, financial information, and a moving picture.

3. The apparatus of claim 1, wherein the electronic signature information generation unit additionally receives one or more of user-private information, a watermark, a signature, and ciphertext, and includes the additionally received information in the electronic signature information.

4. The apparatus of claim 1, wherein the multi-dimensional code output unit receives the multi-dimensional code from the multi-dimensional code generation unit via a recognizing device.

5. The apparatus of claim 1, wherein the multi-dimensional code output unit receives the multi-dimensional code from the multi-dimensional code generation unit using a wired cable or wireless data transfer method.

6. The apparatus of claim 1, wherein the multi-dimensional code output unit outputs the multi-dimensional code onto the document as a plurality of multi-dimensional codes so that the plurality of multi-dimensional codes is spaced apart from each other.

7. The apparatus of claim 1, further comprising a storage unit configured to store the generated multi-dimensional code.

8. A method of performing privacy-protecting document authentication, comprising:
scanning, by a scanning unit, a multi-dimensional code on a document on which the multi-dimensional code including electronic signature information is indicated;
decoding, by a decoding unit, the scanned multi-dimensional code;
extracting, by an electronic signature information extraction unit, the electronic signature information from results of the decoding; and
verifying, by a verification unit, the extracted electronic signature information.

9. The method of claim 8, wherein:
the electronic signature information additionally includes one or more of user-private information, a watermark, a signature, and ciphertext; and
the decoding decodes the additionally included information together with the multi-dimensional code.

10. The method of claim 9, wherein the extracting extracts the additionally included information together with the electronic signature information.

11. The method of claim 10, wherein the verifying verifies the additionally included information together with the electronic signature information.
